(19) United States
(12) Patent Application Publication
(10) Pub. No.: US 2018/0090094 A1
(43) Pub. Date: Mar. 29, 2018

(54) DISPLAY SUBSTRATE AND DRIVING METHOD THEREOF, DISPLAY APPARATUS

(71) Applicant: BOE TECHNOLOGY GROUP CO., LTD., Beijing (CN)

(72) Inventor: Chulgyu JUNG, Beijing (CN)

(21) Appl. No.: 15/705,833

(22) Filed: Sep. 15, 2017

(30) Foreign Application Priority Data
Sep. 26, 2016 (CN) 201610849791.4

(51) Int. Cl. G09G 3/36

(52) U.S. Cl. CPC G09G 3/3688; G09G 3/3677; G09G 2300/0426; G09G 2310/0251; G09G 2310/08

(57) ABSTRACT

This disclosure provides a display substrate and a driving method thereof, and a display apparatus. The driving method of a display substrate comprising a plurality of data lines and a plurality of gate lines, the data lines and the gate lines define a plurality of pixel units, each of the pixel units comprises a switch transistor and a pixel electrode connected with the switch transistor, wherein the driving method comprises steps of: inputting gate signals to a gate lines so as to turn on switch transistors of the pixel units controlled by the gate lines; inputting data signals to the data lines, so that the data lines output the data signals to the pixel electrodes through the switch transistors, wherein a charging time of one pixel electrode is larger than that of a pixel electrode closer to the signal input terminal of the data line than the one pixel electrode.

### CROSS-REFERENCE TO RELATED APPLICATION

The present application claims priority to Chinese Patent Application No. 201610849791.4 filed on Sep. 26, 2016, entitled “a display substrate and a driving method thereof, and a display apparatus”, the disclosure of which is hereby incorporated by reference in its entirety.

### TECHNICAL FIELD

The present disclosure relates to the field of display technology, and particularly, to a display substrate and a driving method thereof, and a display apparatus.

### BACKGROUND ART

Today, a large panel with high resolution, such as a 8K liquid crystal display (LCD) panel, has advantages of high load value and short charging time, so it is widely used in a variety of display technologies and driving technologies.

In the prior art shown in FIG. 1, a liquid crystal display panel comprises a display substrate 4, which is connected with a data driving IC (integrated circuit) and a gate driving IC. The display substrate 4 includes a plurality of data lines 2 and a plurality of gate lines 1. The plurality of data lines 2 are connected with the data driving IC which inputs data signals to the data lines 2. A terminal of each of the data lines 2 connected with the data driving IC is referred to as a signal input terminal. The gate driving IC is connected with the plurality of gate lines 1 to input gate signals to the gate lines 1. The gate lines 1 and the data lines 2 define a plurality of pixel units 3, each of the pixel units 3 comprises a switch transistor and a pixel electrode 5 connected with the switch transistor, the gate line 1 is configured to turn on or off the switch transistor based on a gate signal. The gate signal is firstly input to the 1st gate line, and then to the 2nd gate line to the n-th gate line one by one, that is, the display substrate is driven by scanning in an order from top to bottom. Taking a scanning frequency of 60 Hz as an example, duration of each frame is 1/60 sec=16.7 ms. The data line 2 is configured to input a data signal to the pixel electrode 5 to charge the pixel electrode 5 when the switch transistor is turned on.

However, since each of data lines is connected with too much pixel units, a timing at which a data signal transmitted by one data line arrives at a pixel electrode in a pixel unit close to the signal input terminal of the data line is different from a timing at which the data signal arrives at a pixel electrode in a pixel unit far from the signal input terminal of the data line, so that a charging time of the pixel electrode in the pixel unit close to the signal input terminal of the data line is larger than that of the pixel electrode in the pixel unit far from the signal input terminal of the data line, resulting in that a charging ratio of the pixel electrode in the pixel unit far from the signal input terminal of the data line is lower than that of the pixel electrode in the pixel unit close to the signal input terminal of the data line. As shown in FIG. 2, the charging ratio of the pixel electrode in the pixel unit close to the signal input terminal of the data line is 100%, the charging ratio of the pixel electrode in the pixel unit far from the signal input terminal of the data line is 56%, and a charging ratio of the pixel electrode in the pixel unit at a middle position of the data line is 70%. It can be seen that with the increase of distance of the pixel unit to the signal input terminal of the data line, the charging ratio of the pixel electrode in the pixel unit is decreased.

In order to solve this problem in the prior art, as shown in FIGS. 3 and 4, an existing solution is to increase the number of the data lines by two times as much as before, that is, two data lines are used to control the pixel units which are controlled by one data line before. Therefore, the number of the pixel units controlled by each data line can be reduced by half, and the charging time of the pixel electrode in the pixel unit away from the signal input terminal of the data line can be increased from Th to 2*Th, so as to solve the problem of low charging ratio of the pixel electrode away from the signal input terminal of the data line due to insufficient charging time. However, since the increase of the number of the data lines, productivity of the products is decreased and the cost of the product is increased.

### SUMMARY

In view of at least one of the above problems in the prior art, the present disclosure proposes a display substrate and a driving method of the same, and a display apparatus, which can increase the charging ratio of the pixel electrode away from the signal input terminal of the data line and can avoid reduction of the productivity of the products and increase of the cost of the product.

A solution adopted to solve the above problems is a driving method of a display substrate, the display substrate comprises a plurality of data lines and a plurality of gate lines, the data lines and the gate lines define a plurality of pixel units, each of the pixel units comprises a switch transistor and a pixel electrode connected with the switch transistor, wherein the driving method comprises steps of:

inputting gate signals to the gate lines so as to turn on switch transistors of pixel units controlled by the gate lines;

inputting data signals to a data lines, so that the data lines output the data signals to the pixel electrodes through the switch transistors,

wherein a charging time of a pixel electrode away from a signal input terminal of the data line is larger than that of a pixel electrode close to the signal input terminal of the data line.

Optionally, a starting time when the data signal is output to the pixel electrode is controlled by using a driving signal, the driving signal includes a plurality of cycles, a number of the cycles is the same as a number of rows of pixel units, and the plurality of cycles correspond to the rows of pixel units in one-to-one correspondence relationship;

durations of the cycles of the driving signal are increased sequentially in an order from the pixel electrode closest to the signal input terminal of the data line to the pixel electrode farthest from the signal input terminal of the data line.

Optionally, the durations of the cycles of the driving signal are increased sequentially in a linear relationship in an order from the pixel electrode closest to the signal input terminal of the data line to the pixel electrode farthest from the signal input terminal of the data line.

Optionally, a cycle of the driving signal includes a low-level duration and a high-level duration in order, the data signal input to the data line starts to charge the pixel unit at a timing when the driving signal becomes a low level.

Optionally, the low-level duration of a cycle of the driving signal corresponding to one pixel electrode is shorter than that of a cycle of the driving signal corresponding to a pixel electrode farther from the signal input terminal of the data line than the one pixel electrode.

Optionally, the high-level duration of a cycle of the driving signal corresponding to one pixel electrode is the same as that of a cycle of the driving signal corresponding to a pixel electrode farther from the signal input terminal of the data line than the one pixel electrode.

Optionally, a sum of the durations of cycles of the driving signal corresponding to each gate line is less than or equals to a duration of a frame of a sub signal.

Optionally, when the gate signal is at a high level, thin film transistors of pixel units corresponding to a gate line to which the gate signal is input are turned on, and when the gate signal is at a low level, the thin film transistors of the pixel units corresponding to the gate line to which the gate signal is input are turned off, and charging of the data signal with respect to the pixel electrode is completed;

the charging time is a time period between a timing when the gate signal is at the high level and the driving signal is at a low level and a timing when the gate signal becomes a low level.

In another aspect, this disclosure further provides a display substrate driven by the above driving method, the display substrate comprises:

a plurality of data lines;

a plurality of gate lines, wherein the plurality of data lines and the plurality of gate lines define a plurality of pixel units, each of the pixel units includes a switch transistor and a pixel electrode connected with the switch transistor;

a gate driving circuit which inputs gate signals to the plurality of gate lines so as to turn on the switch transistors of pixel units controlled by the gate lines;

a data driving circuit which inputs data signals to the plurality of data lines so that the data lines output the data signals to the pixel electrodes through the switch transistors,

wherein the data driving circuit further generates and outputs a driving signal so that, by the driving signal, a charging time of a pixel electrode away from a signal input terminal of the data line is larger than that of a pixel electrode close to the signal input terminal of the data line.

In yet another aspect, this disclosure provides a display apparatus, which comprises the above display substrate.

In the display substrate and the driving method thereof, and the display apparatus of the present disclosure, the driving method of the display substrate comprises: inputting a gate signal to a gate line so as to turn on a switch transistor of a pixel unit controlled by the gate line; inputting a data signal to a data line, so that the data line outputs the data signal to the pixel electrode through the switch transistor. By controlling the charging time of the pixel electrode, the charging time of the pixel electrode away from the signal input terminal of the data line is larger than that of the pixel electrode close to the signal input terminal of the data line, so that the charging ratio of the pixel electrode away from the signal input terminal of the data line is increased, meanwhile, increase of the number of the data lines is avoided, and decrease of productivity of the products and increase of the cost of the product can be effectively avoided.

### BRIEF DESCRIPTION OF THE DRAWINGS

FIG. 1 is a structural diagram of an existing display substrate;

FIG. 2 is a diagram showing a charging condition of a pixel electrode of the display substrate shown in FIG. 1;

FIG. 3 is a structural diagram of another existing display substrate;

FIG. 4 is a diagram showing a charging condition of a pixel electrode of the display substrate shown in FIG. 3;

FIG. 5 is a flow chart of a driving method of a display substrate in a first embodiment of the present disclosure; and

FIG. 6 is a schematic diagram of a driving method of the display substrate in the first embodiment of the present disclosure;

Reference numerals: 1. gate line; 2. data line; 3. pixel unit; 4. display substrate; 5. pixel electrode.

### DETAILED DESCRIPTION OF THE EMBODIMENTS

In order to make a person skilled in the art understand the solutions in this disclosure better, the solutions will be described below in detail in conjunction with the accompanying drawings and specific implementations.

### First Embodiment

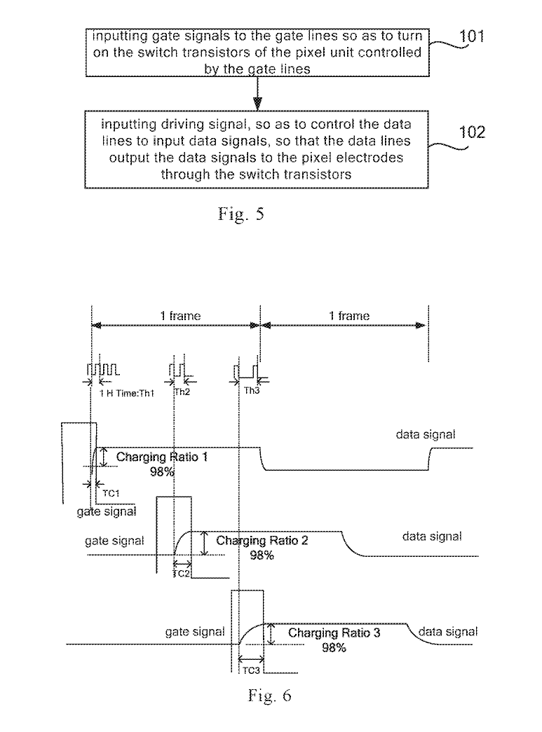

Referring to FIGS. 5 and 6, this embodiment provides a driving method of a display substrate comprising a plurality of data lines and a plurality of gate lines, the data lines and the gate lines define a plurality of pixel units, each of the pixel units comprising a switch transistor and a pixel electrode connected with the switch transistor. The display substrate is connected with a data driving IC and a gate driving IC.

The driving method of the display substrate in this embodiment comprises:

Step 101, inputting gate signals to the gate lines so as to turn on the switch transistors of the pixel units controlled by the gate lines.

This step is performed by the gate driving IC, that is, the gate driving IC inputs the gate signals to the gate lines. In other words, the gate driving IC outputs a gate signal to each row of gate lines in turn, so that the gate signal is first input to one pixel unit closest to the signal input terminal of the data line, then input to other pixel units farther from the signal input terminal of the data line than the one pixel unit in turn, that is, the gate lines of the display substrate are scanned in an order from top to bottom.

Step 102, inputting data signals to the data lines based on the gate signals, so that the data lines output the data signals to the pixel electrodes through the switch transistors.

Specifically, the data driving IC outputs the data signals to the data lines, generates and outputs a driving signal, and controls the data signal input into each pixel unit based on the driving signal so that the data signals can charge the pixel electrodes at proper timings respectively.

In this embodiment, charging time of one pixel electrode is larger than that of another pixel electrode closer to the signal input terminal of the data line than the one pixel electrode.

It should be noted that the charging time refers to a time period in which the data signal is input to the pixel unit. The reason for thus arrangement is that, the charging times of the pixel electrodes are controlled so that the charging time of one pixel electrode is larger than that of a pixel electrode closer to the signal input terminal of the data line than the one pixel electrode, thus the charging ratio of the pixel electrode away from the signal input terminal of the data line can be increased, meanwhile, increase of the number of the data lines can be avoided and thus reduction of the productivity of the products and increase of the cost of the product can also be avoided.

A starting time when the data signal is output to the pixel electrode is controlled by using a driving signal. The driving signal includes a plurality of cycles. The number of the cycles is the same as the number of rows of pixel units, and the plurality of cycles correspond to the rows of pixel units in one-to-one correspondence relationship, that is, one cycle corresponds to one row of pixel units; durations of the cycles of the driving signal are increased sequentially in an order from a pixel electrode closest to the signal input terminal of the data line to a pixel electrode farthest from the signal input terminal of the data line.

With reference to FIG. 6, it is assumed that a cycle of the driving signal output to the pixel electrode closest to the signal input terminal of the data line is Th1, a cycle of the driving signal output to the pixel electrode farthest to the signal input terminal of the data line is Th3, and a cycle of the driving signal output to a pixel electrode located at a middle position of the data line is Th2, it can he seen that Th3>Th2>Th1. By increasing the durations of the cycles of the driving signal corresponding to the pixel electrodes away from the signal input terminal of the data line, the charging ratios of the pixel electrodes away from the signal input terminal of the data line can be increased, thus causing charging ratios of the pixel electrodes in the plurality of pixel units controlled by a same data line to be the same and to reach to 98%.

Obviously, the charging ratio is not limited to 98%, and the charging time may be adjusted according to practical conditions to control the charging ratios of the pixel units, which will not be repeated herein.

Optionally, the durations of the cycles of the driving signal are increased in a linear relationship in an order from the pixel electrode closest to the signal input terminal of the data line to the pixel electrode farthest from the signal input terminal of the data line.

Obviously, the durations of the cycles of the driving signal may be increased in any other function relationship in an order from the pixel electrode closest to the signal input terminal of the data line to the pixel electrode farthest from the signal input terminal of the data line, which will not be repeated herein.

Each cycle of the driving signal includes a low-level duration and a high-level duration in order, and the data signal input to the data line starts to charge the pixel electrodes at a timing when the driving signal becomes a low level.

It can be seen from FIG. 6 that each cycle of the driving signal includes a low-level duration and a high-level duration, and begins at a timing when a low level begins and ends at a timing when the high level ends. The low level is used to control the data line to input the data signal to the pixel electrode, that is, the data signal input by the data line charges the pixel electrode at the timing when the driving signal becomes the low level. In other words, after a switch transistor of a pixel unit is turned on by the gate signal, when a low level of the driving signal begins, the data signal may be input into the pixel unit, and the data signal is input into the pixel electrode so as to charge the pixel electrode. After the switch transistor of the pixel unit is turned off by the gate signal, the data signal cannot be input into the pixel unit any longer, thus stopping charging the pixel electrode. That is, when the gate signal is at a high level and the driving signal is at a low level, the data signal starts to charge the pixel electrode; on the other hand, when the gate signal is at a low level, the data signal stops charging the pixel electrode regardless whether the driving signal is at a high level or a low level.

The low-level duration of a cycle of the driving signal corresponding to one pixel electrode is shorter than that of a cycle of the driving signal corresponding to a pixel electrode farther from the signal input terminal of the data line than the one pixel electrode.

The high-level duration of a cycle of the driving signal corresponding to one pixel electrode is the same as that of a cycle of the driving signal corresponding to a pixel electrode farther from the signal input terminal of the data line than the one pixel electrode.

It can be seen from FIG. 6 that the high-level durations of the cycles Th1, Th2 and Th3 are the same, but the low-level duration of of the cycle Th3 is larger than that of the cycle Th2, and the low-level duration of the cycle Th2 is larger than that of the cycle Th1, that is, a total duration of the cycle Th1 is shorter than that of the cycle Th2, and a total duration of the cycle Th2 is shorter than that of the cycle Th3. Therefore, the farther from the signal input terminal of the data line the pixel electrode is, the longer the charging time thereof is, thereby causing the charging ratio of the pixel electrode far from the signal input terminal of the data line to be the same as that of the pixel electrode close to the signal input terminal of the data line.

By controlling the charging time of the pixel electrode in the way as described above, the charging ratio of the pixel electrode away from the signal input terminal of the data line is increased, and it is unnecessary to provide data lines two times as much as before. Therefore, decrease of productivity of the products and increase of the cost of the product can be effectively avoided.

The data signal includes a plurality of frames of sub-signal, and a duration of each frame of sub-signal is equal to a reciprocal of a frequency of a scan signal for the gate lines.

Specifically, taking the scan signal having a frequency of 60 Hz as an example, the duration of each frame of the sub-signal is 1/60 sec=16.7 ms. Obviously, the frequency of the scan signal can be set as practically required. Therefore, the duration of each frame of sub-signal may be changed accordingly, which will not be repeated herein.

A sum of durations of cycles of the driving signal corresponding to each gate line is less than or equal to a duration of each frame of a sub-signal. That is to say, the duration of each frame of the sub-signal consists of the durations of a plurality of the cycles of the driving signal.

When the gate signal is at a high level, the thin film transistors of the pixel units corresponding to a gate line to which the gate signal is input are turned on, allowing the data signals to charge the pixel electrodes under the control of the driving signal. When the gate signal is at a low level, the thin film transistors of the pixel units corresponding to a gate line to which the gate signal is input are turned off, and charging of the data signals to the pixel electrodes is completed.

A charging time TC1 is a time period between a timing when the gate signal is at the high level and the driving signal is at the low level and a timing when the gate signal becomes the low level.

The driving method of the display substrate in this embodiment comprises: inputting gate signals to gate lines so as to turn on switch transistors of pixel units controlled by the gate line; inputting data signals to data lines, so that the data lines output the data signals to the pixel electrodes through the switch transistors according to the driving signal; by controlling the charging time of the pixel electrodes, the charging time of a pixel electrode away from the signal input terminal of the data line is larger than that of a pixel electrode close to the signal input terminal of the data line so as to increase the charging ratio of the pixel electrode away from the signal input terminal of the data line while avoiding increase of the number of the data lines, and thereby decrease of productivity of the products and increase of the cost of the product can be effectively avoided.

### Second Embodiment

This embodiment provides a display substrate, which is driven by the driving method in the first embodiment. Specifically, the display substrate in this embodiment comprises:

a plurality of data lines;

a plurality of gate lines, wherein the plurality of data lines and the plurality of gate lines define a plurality of pixel units, each of the pixel units includes a switch transistor and a pixel electrode connected with the switch transistor;

a gate driving circuit which inputs gate signals to the plurality of gate lines so as to turn on switch transistors of the pixel units controlled by the gate lines; and
a data driving circuit which inputs data signals to the plurality of data lines so that the data lines output the data signals to the pixel electrodes through the switch transistors,

wherein the data driving circuit further generates and outputs a driving signal so that, by the driving signal, a charging time of one pixel electrode is larger than that of a pixel electrode closer to the signal input terminal of the data line than the one pixel electrode.

Specific implementations of controlling the charging time of the data signals with respect to the pixel electrodes by using the driving signal and arrangment of the driving signal are the same as those in the first embodiment, which will not he repeated herein.

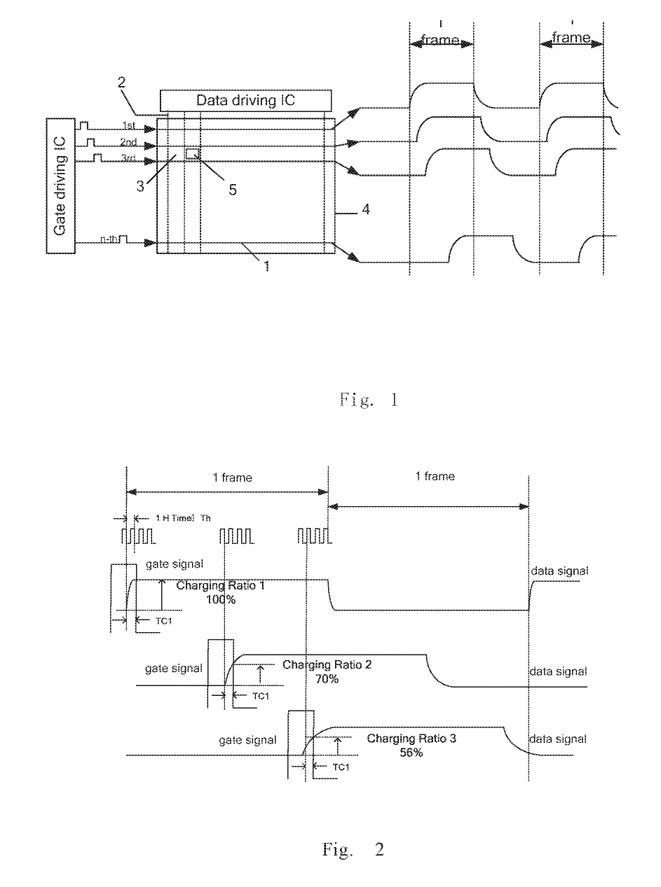

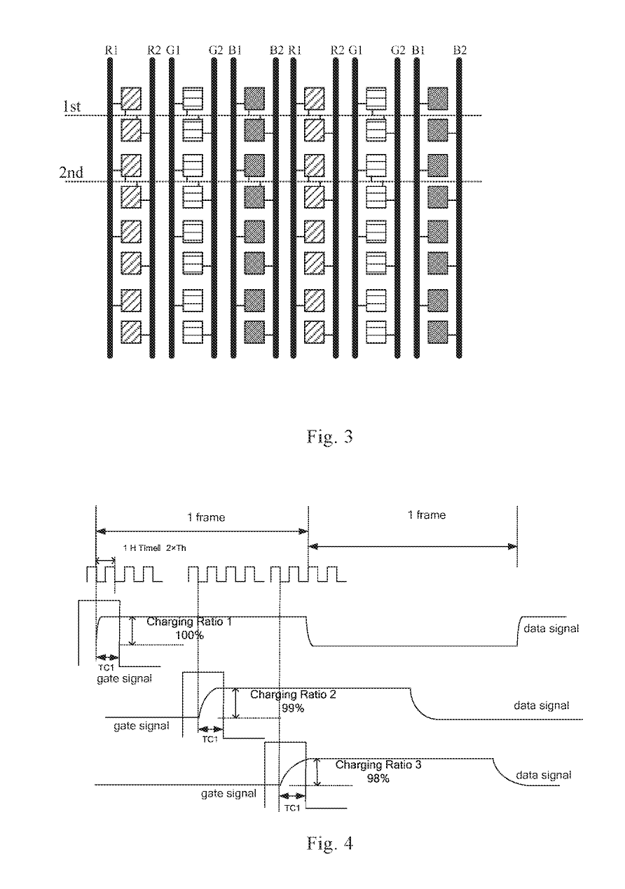

In addition, basic structure of the display substrate in this embodiment may be referred to FIG. 1. However, the display substrate in this embodiment and that in the prior art as shown in FIG. 1 are different in that: the data driving circuit of the display substrate in this embodiment is further configured to generate and input the driving signal for controlling the charging time of the data signals with respect to the pixel electrodes, specific control way may refer to the first embodiment, which will not be repeated herein.

In the display substrate in this embodiment, by controlling the charging time of the pixel electrodes, the charging time of a pixel electrode away from the signal input terminal of the data line is larger than that of a pixel electrode close to the signal input terminal of the data line so as to increase the charging ratio of the pixel electrode away from the signal input terminal of the data line while avoiding increase of the number of the data lines, and thereby decrease of productivity of the products and increase of the cost of the product can be effectively avoided.

### Third Embodiment

This embodiment provides a display panel comprising the display substrate in the second embodiment.

In the display panel in this embodiment, by controlling the charging time of the pixel electrodes, the charging time of a pixel electrode away from the signal input terminal of the data line is larger than that of a pixel electrode close to the signal input terminal of the data line, so as to increase the charging ratio of the pixel electrodes away from the signal input terminal of the data line while avoiding increase of the number of the data lines, and thereby decrease of productivity of the products and increase of the cost of the product can be effectively avoided.

### Fourth Embodiment

This embodiment provides a display apparatus, which comprises the display panel in the third embodiment. The display apparatus may be any product or element having a display function, such as an electronic paper, a mobile phone, a tablet computer, a television, a display, a notebook computer, a digital photo frame and a navigator.

In the display apparatus in this embodiment, by controlling the charging time of the pixel electrodes, the charging time of a pixel electrodes away from the signal input terminal of the data line is larger than that of a pixel electrode close to the signal input terminal of the data line so as to increase the charging ratio of the pixel electrode away from the signal input terminal of the data line while avoiding increase of the number of the data lines, and thereby decrease of productivity of the products and increase of the cost of the product can be effectively avoided.

It should be understood that, the foregoing embodiments are only exemplary embodiments used for explaining the principle of the present invention, but the present invention is not limited thereto. Various variations and improvements may be made by a person skilled in the art without departing from the protection scope of the present invention, and these variations and improvements also fall into the protection scope of the present invention.

1. A driving method of a display substrate comprising a plurality of data lines and a plurality of gate lines, the data lines and the gate lines define a plurality of pixel units, each of the pixel units comprises a switch transistor and a pixel electrode connected with the switch transistor, wherein the driving method comprises steps of:
inputting gate signals to the gate lines so as to turn on switch transistors of pixel units controlled by the gate lines;
inputting data signals to a data lines, so that the data lines output the data signals to the pixel electrodes through the switch transistors,
wherein a charging time of a pixel electrode away from a signal input terminal of the data line is larger than that of a pixel electrode close to the signal input terminal of the data line.

2. The driving method of claim 1, wherein a starting time when the data signal is output to the pixel electrode is controlled by using a driving signal, the driving signal includes a plurality of cycles, a number of the cycles is the same as a number of rows of pixel units, and the plurality of cycles correspond to the rows of pixel units in one-to-one correspondence relationship;
durations of the cycles of the driving signal are increased sequentially in an order from the pixel electrode closest to the signal input terminal of the data line to the pixel electrode farthest from the signal input terminal of the data line.

3. The driving method of claim 2, wherein the durations of the cycles of the driving signal are increased sequentially in a linear relationship in an order from the pixel electrode closest to the signal input terminal of the data line to the pixel electrode farthest from the signal input terminal of the data line.

4. The driving method of claim 2, wherein a cycle of the driving signal includes a low-level duration and a high-level duration in order, and the data signal input to the data line starts to charge the pixel electrode at a timing when the driving signal becomes a low level.

5. The driving method of claim 4, wherein the low-level duration of a cycle of the driving signal corresponding to one pixel electrode is shorter than that of a cycle of the driving signal corresponding to a pixel electrode farther from the signal input terminal of the data line than the one pixel electrode.

6. The driving method of claim 4, wherein the high-level duration of a cycle of the driving signal corresponding to one pixel electrode is the same as that of a cycle of the driving signal corresponding to a pixel electrode farther from the signal input terminal of the data line than the one pixel electrode.

7. The driving method of claim 6, wherein a sum of the durations of cycles of the driving signal corresponding to each gate line is less than or equals to a duration of a frame of a sub signal.

8. The driving method of claim 4, wherein, when the gate signal is at a high level, thin film transistors of pixel units corresponding to a gate line to which the gate signal is input are turned on, and when the gate signal is at a low level, the thin film transistors of the pixel units corresponding to the gate line to which the gate signal is input are turned off, and charging of the data signal for the pixel electrode is completed;
the charging time is a time period between a timing when the gate signal is at the high level and the driving signal is at the low level and a timing when the gate signal becomes the low level.

9. A display substrate comprising:
a plurality of data lines;
a plurality of gate lines, wherein the plurality of data lines and the plurality of gate lines define a plurality of pixel units, each of the pixel units includes a switch transistor and a pixel electrode connected with the switch transistor;
a gate driving circuit which inputs gate signals to the plurality of gate lines so as to turn on the switch transistors of pixel units controlled by the gate lines;
a data driving circuit which inputs data signals to the plurality of data lines so that the data lines output the data signals to the pixel electrodes through the switch transistors,
wherein the data driving circuit further generates and outputs a driving signal so that, by the driving signal, a charging time of a pixel electrode away from a signal input terminal of the data line is larger than that of a pixel electrode close to the signal input terminal of the data line.

10. The display substrate of claim 9, wherein the data driving circuit controls a starting time when the data signal is output to the pixel electrode by using a driving signal, the driving signal includes a plurality of cycles, a number of the cycles is the same as a number of rows of pixel units, and the plurality of cycles correspond to the rows of pixel units in one-to-one correspondence relationship; and
wherein durations of cycles of the driving signal are increased sequentially in an order from a pixel electrode closest to the signal input terminal of the data line to a pixel electrode farthest from the signal input terminal of the data line.

11. The display substrate of claim 10, wherein the durations of the cycles of the driving signal are increased sequentially in a linear relationship in an order from the pixel electrode closest to the signal input terminal of the data line to the pixel electrode farthest from the signal input terminal of the data line.

12. The display substrate of claim 10, wherein a cycle of the driving signal includes a low-level duration and a high-level duration in order, the data signal input to the data line starts to charge the pixel unit at a timing when the driving signal becomes a low level.

13. The display substrate of claim 12, wherein the low-level duration of a cycle of the driving signal corresponding to one pixel electrode is larger than that of a cycle of the driving signal corresponding to a pixel electrode farther from the signal input terminal of the data line than the one pixel electrode.

14. The display substrate of claim 12, wherein the high-level duration of a cycle of the driving signal corresponding to one pixel electrode is larger than that of a cycle of the driving signal corresponding to a pixel electrode farther from the signal input terminal of the data line than the one pixel electrode.

15. The display substrate of claim 14, wherein a sum of the durations of cycles of the driving signal corresponding to each gate line is less than or equals to a duration of a frame of a sub-signal.

16. The display substrate of claim 12, wherein, when the gate signal is at a high level, thin film transistors of pixel units corresponding to a gate line to which the gate signal is input are turned on, and when the gate signal is at a low level, the thin film transistors of a pixel units corresponding to the gate line to which the gate signal is input are turned off, and charging of the data signal with respect to the pixel electrode is completed;
a charging time is a time period between a timing when the gate signal is at the high level and the driving signal is at the low level and a timing when the gate signal becomes the low level.

17. A display apparatus comprising the display substrate of claim 9.

18. A display apparatus comprising the display substrate of claim 10.

19. A display apparatus comprising the display substrate of claim 11.

20. A display apparatus comprising the display substrate of claim 12.
